(19) United States
(12) Patent Application Publication
(10) Pub. No.: US 2007/0263664 A1
(43) Pub. Date: Nov. 15, 2007

(54) Network bandwidth monitoring & regulating system

(75) Inventor: Li-Cheng Yang, Taipei (TW)

Correspondence Address: BIRCH STEWART KOLASCH & BIRCH, PO BOX 747, FALLS CHURCH, VA, 22040-0747, US

(73) Assignee: AmRoad Technology Inc., Chung Ho City (TW)

(21) Appl. No.: 11/798,012

(22) Filed: May 9, 2007

(30) Foreign Application Priority Data
May 9, 2006 (TW) 095116468

(51) Int. Cl. H04J 3/18; H04L 12/26

(52) U.S. Cl. 370/477; 370/235

(57) ABSTRACT

A network bandwidth monitoring and regulating system to retrieve a optimal bandwidth area for reducing risk of losing the packet and upgrading network quality including a packet loss rate and a jitter of packet delayed variance value complying with RFC 3550; and a network bandwidth of the system being divided into redundant, optimal bandwidth, and congestion areas assigned and distinguished according to presence of rise of the jitter of packet delayed variance value and the packet loss rate.

### FIELD OF THE INVENTION

The present invention relates to a network monitoring system, and more particularly to a network bandwidth monitoring and regulating system.

### BACKGROUND OF THE INVENTION

In a time enjoying prosperous development of technology, network is like a nervous system than connects in series each and all organs in human body; and just so much as that, network in the course of transmission is vulnerable to lose packet. There are three primary causes contribute to losing the packet. The first cause is related to general loss. A packet may be lost during transmission since the network transmission is not reliable and the normal chance of losing a packet is 1%˜5%. However, the chance varies depends of the capability of node facilities of the network. That is, the stronger capability of the node facilities is, and the chance of losing a packet gets lower; and the weaker, the higher. Insufficient bandwidth is the second cause. The network is also just like a water pipe involving the size of flow. If a band width of the node in a certain section of the transmission route of the network is smaller than that of the dataflow to be transmitted, the data will be dumped due to insufficient bandwidth. The third cause involves competition loss, wherein if two lots of data are inputted at the same time, both may compete for the bandwidth resulting in losing a packet data.

Accordingly, several network congestion control mechanisms have been introduced to cope with unreliable data transmission. Some of the mainstream methods are described as follows:

### TCP-Like Rate Control:

This control mechanism generally referring to completion of the process of congestion control and re-sending after computation using parameters including TCP, RTT and Packet lose though achieves the purpose of flow control, problems of just-in-time and excessive delay changes, and compatibilities of Router and NAT exist.

### TCP-Friendly Rate Control (TFRC):

When a congestion control mechanism similar to TCP is applied to realize on RTP, its parameters must be present in the same packet with the playload; therefore, the header of the RTP will be changed to meet TCP computation. Since the time of RTT must be based on the time of the physical transmission packet, separate test is prevented to invite the problem of compatibility with Hierarchy 5 transmission protocol.

### Datagram Congestion Control Protocol (DCCP):

Designed for the failure of UDP to find out network congestion status according to DCCP while giving considerations to just-in-time and network congestion report mechanism, this method however is still in its draft stage and is not compatible with UDP.

Whereas the prior arts described above suffer the problem of compatibility with the current network, the present invention provides a network bandwidth monitoring and regulating system that is compatible with the current transmission protocol to solve those defectives found with the prior art.

### SUMMARY OF THE INVENTION

A primary object of the present invention is to provide a network bandwidth monitoring and regulating system that takes the initiative to predict an optimal bandwidth area B through a jitter report mechanism of packet delayed variance value in the RTCP in conjunction with packet loss rate for effective reduction of network packet loss rate to upgrade network transmission quality.

Another object of the present invention is to provide a network bandwidth monitoring and regulating system that is compatible with the current network protocol in a form complying with RFC3550 standard; wherein RTCP data are updated once within a time as short as 50 ms to retrieve the average variation, Jₐᵥₑ, of the average jitter of packet delayed variance value, for improving the accuracy of the jitter of packet delayed variance value.

Another object yet of the present invention is to provide a network bandwidth monitoring and regulating system to prevent the data volume transmitted from going beyond the real load of the network by converting the passive learning of modifying the bandwidth after the loss of massive packets to active prediction since either audio or video will become distorted upon the loss of the packet data.

To achieve the above and other objects, the present invention discloses a network monitoring and regulating system, and more particularly, to a network bandwidth monitoring and regulation system including a packet loss rate in conjunction with a jitter of a packet delayed variance value defined within an additional control information of RTCP that complies with the latest RFC 3550 standard to respectively correspond to an redundant area A, an optimal bandwidth area B, and a congestion area C. The redundant area A is assigned to the condition in the absence of significant rise of both of the jitter of packet delayed variance value, and the packet loss rate; the optimal bandwidth area B, the jitter of packet delayed variance value starts to rise but there is no change to the packet loss rate; and the congestion area C, both of the jitter of packet delayed variance value and the packet loss rate are rising. Finally, all three areas including the redundant area A, the optimal bandwidth area B, and the congestion area Care distinguished from one another by the jitter of packet delayed variance value and the packet loss rate thus to take the initiative to retrieve the optimal bandwidth area B. Obtaining the optimal bandwidth area B through prediction reduces risk of losing the packet thus to upgrade network quality.

### BRIEF DESCRIPTION OF THE DRAWINGS

FIG. 1 is a chart of coordinates of the real data volume/delayed time and data transmission volume of the present invention.

FIG. 2 is a chart of coordinates of the packet loss rate and data transmission volume of the present invention.

FIG. 3 is a chart of coordinates of the JITTER of packet delayed variance value and data transmission volume of the present invention.

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings, wherein:

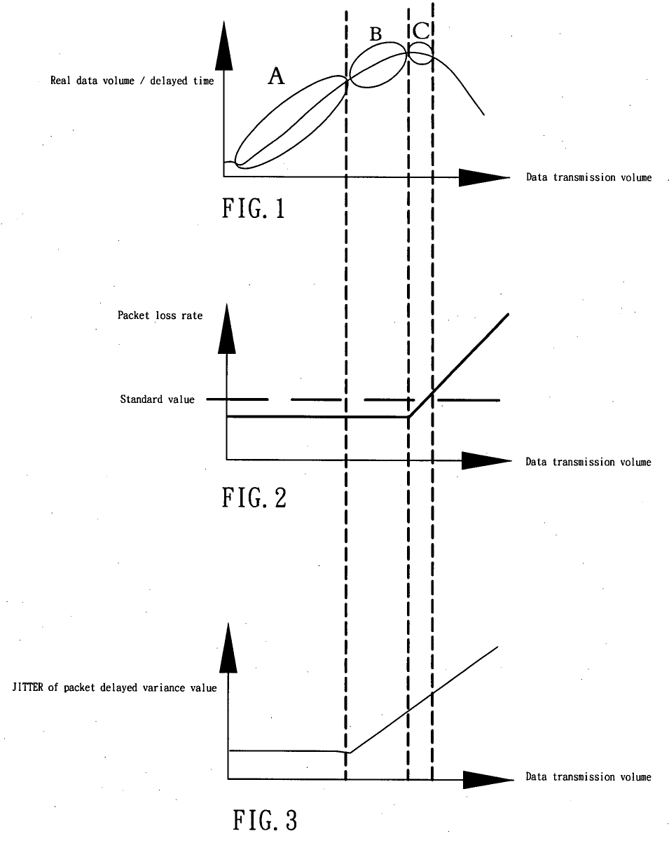

Referring to FIG. 1 for a chart of coordinates of the real data volume/delayed time and data transmission volume of the present invention, FIG. 2 for a chart of coordinates of the packet loss rate and data transmission volume of the present invention, and FIG. 3 for a chart of coordinates of the jitter of packet delayed variance value and data transmission volume of the present invention, a network bandwidth 10 (not illustrated) is divided into three areas, respectively, a redundant area A, an optimal bandwidth area B, and a congestion area C. The redundant area represents a comparatively redundant bandwidth to permit increase of data volume; the optimal bandwidth area B represents the currently available optimal bandwidth; and the congestion area C represents where congestion presents for the area to readily expose to risk of losing data. Additional control information of RTCP (real-time control protocol) contains a mechanism to report the jitter of packet delayed variance value. The jitter of packet delayed variance value presents due to delay resulted from network competition (multiple packets are transmitted at the same time). A lower jitter of packet delayed variance value means the less competition in network, thus the reduced chance of losing the packet and the better network quality. However, a higher jitter of packet delayed variance value indicates frequent competition in network, thus the higher risk of losing packet to compromise network quality. Compliance with RFC3550 standard means RTCP data can be updated once within a time as short as 50 ms so to upgrade accuracy of data. Meanwhile, the packet loss rate is provided with a certain standard value. When the standard value of the packet loss rate is surpassed, distortions of both audio and video start take place. Therefore, it takes to convert from passive learning of the necessity of modifying the bandwidth after massive lose of packet to active prediction so to prevent losing packet data when a data volume transmitted becomes greater than a real load of the network. Furthermore, when no significant rise of both of the jitter of packet delayed variance value and the packet loss rate, the redundant area A is assigned; when the jitter of packet delayed variance value starts to rise but the packet loss rate does not, the optimal bandwidth area B; and when both of the jitter of packet delayed variance value and the packet loss rate rise at the same time, the congestion area C. Accordingly, three areas of the redundant area A, the optimal bandwidth area B, and the congestion area C are distinguished according to the jitter of packet delayed variance value in conjunction with the packet loss rate so to retrieve the optimal bandwidth area B while being compatible with RFC3550 standard. The optimal bandwidth area B is obtained by taking first a packet delayed variance standard value in the following procedure:
a. Obtaining an average variance of Jₐᵥₑ of an averaged jitter from the latest multiple packet delayed variance values;
b. Locating a minimal jitter, Jₘᵢₙ, and a maximal jitter, Jₘₐₓ of the packet delayed variance value under the condition of absence of significant rise of the packet loss rate; and
c. Solving the optimal bandwidth area B at where with the jitter of packet delayed variance value falling between values of Jₘₐₓ−Jₐᵥₑ and Jₘₐₓ−(2×Jₐᵥₑ).

The jitter of the packet delayed variance value in the redundant area A is smaller than the value of Jₘₐₓ−(2×Jₐᵥₑ), and the jitter of the packet delayed variance value in the congestion area C is greater than the value of Jₘₐₓ−Jₐᵥₑ−. All Jₘᵢₙ, Jₘₐₓ, and Jave values of the packet delayed variance value change depending on then current condition of the network so to achieve the optimal results expected. According to FIGS. 1, 2, and 3, a location of the optimal bandwidth starts to significantly rise after the packet starts to lose due to that a changed jitter of the packet delayed variance value takes place before the optimal bandwidth. Consequently, an active prediction is made feasible on data transmission through the jitter of packet delayed variance value, thus to reduce data transmission volume right before the real load of the network is challenged for further upgrading network quality by preventing packet data from losing in the course of network transmission.

The present invention discloses a network monitoring system, and more particularly, to a network bandwidth monitoring and regulating system including a packet loss rate and a jitter of packet delayed variance value defined in an additional control information of RTCP in compliance with the latest RFC 3550 standard and respectively corresponding to a redundant area A, an optimal bandwidth area B, and a congestion area C. When both of the jitter of packet delayed variance value and the packet loss are observed with no significant rise, the redundant area A is assigned; when the jitter of packet delayed variance value starts to rise but no change is observed with the packet loss rate, the optimal area B is assigned; and when both of the jitter of packet delayed variance value and the packet loss rate rise at the same time, the congestion area is assigned. Finally, three areas including the redundant area A, the optimal bandwidth area B, and the congestion area C are distinguished by the jitter of packet delayed variance value and the packet loss rate in achieving an active retrieval of the optimal bandwidth area B to reduce risk of losing the packet and upgrade network quality for comprehensive application on network facilities.

The present invention by making a breakthrough of the prior art has indeed achieved the results the present invention desires and the present invention prevents easy conception by a person familiar with the skill in this field.

The prevent invention provides a network bandwidth monitoring and regulating system with its progressiveness and utility meeting statutory requirements of a patent, and the application for a patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

What is claimed is:

1. A network bandwidth monitoring and regulating system, comprising a network bandwidth divided into a redundant area A, an optimal bandwidth area B, and a congestion area C; a packet loss rate and a jitter of packet delayed variance value being defined in an additional control information of RTCP in compliance with the latest RFC3550 standard and respectively corresponding to the redundant area A, the optimal bandwidth area B, and the congestion area C; the redundant area A being assigned when both of the jitter of packet delayed variance value and the packet loss are observed with no significant rise; the optimal area B being assigned when the jitter of packet delayed variance value starts to rise but no change is observed with the packet loss rate; and, the congestion area being assigned when both of the jitter of packet delayed variance value and the packet loss rate rise at the same time; and three areas including the redundant area A, the optimal bandwidth area B, and the congestion area C being distinguished by the jitter of packet delayed variance value and the packet loss rate in achieving an active retrieval of the optimal bandwidth area B to reduce risk of losing the packet and upgrade network quality for comprehensive application on network facilities in compliance with the latest network specifications.

2. The network bandwidth monitoring and regulating system as claimed in claim 1, wherein the network bandwidth complies with the latest RFC 3550 standard.

3. The network bandwidth monitoring and regulating system as claimed in claim 1, wherein the jitter of packet delayed variance value complies with the latest RFC 3550 standard.

4. The network bandwidth monitoring and regulating system as claimed in claim 1, wherein the packet loss rate complies with the latest RFC 3550 standard.

5. The network bandwidth monitoring and regulating system as claimed in claim 1, wherein the production of the jitter of packet delayed variance value is resulted from a delay caused by network competition (multiple packets being transmitted at the same time).

6. The network bandwidth monitoring and regulating system as claimed in claim 1, wherein the lower jitter of packet delayed variance value indicates less competition on the network and lower risk of packet loss.

7. The network bandwidth monitoring and regulating system as claimed in claim 1, wherein the higher jitter of packet delayed variance value indicates more network competition and higher risk of packet loss.

8. The network bandwidth monitoring and regulating system as claimed in claim 1, wherein RTCP data is updated once within a time as short as 50 ms in compliance with RFC 3550 standard to upgrade data accuracy.

9. A methodology to acquire the optimal bandwidth area B comprising:
a. Obtaining an average variance of Jₐᵥₑ of an averaged jitter from the latest multiple packet delayed variance values;
b. Locating a minimal jitter, Jₘᵢₙ, and a maximal jitter, Jₘₐₓ of the packet delayed variance value under the condition of absence of significant rise of the packet loss rate; and
c. Solving the optimal bandwidth area B at where with the jitter of packet delayed variance value falling between values of Jₘₐₓ−Jₐᵥₑ and Jₘₐₓ−(2×Jₐᵥₑ).

10. The network bandwidth monitoring and regulating system as claimed in claim 1 or 9, wherein the value of the jitter of packet delayed variance value of the packet in the redundant area A is smaller than that of Jmax−(2×Jave).

11. The network bandwidth monitoring and regulating system as claimed in claim 1 or 9, wherein the value of the jitter of packet delayed variance value of the packet in the congestion area B is greater than that of Jmax−Jave.

12. The network bandwidth monitoring and regulating system as claimed in claim 1 or 9, wherein the minimal value of the jitter, Jmin, of the packet delayed variance value changes depending on the status of the network to achieve the optimal results expected.

13. The network bandwidth monitoring and regulating system as claimed in claim 1 or 9, wherein the maximal value of the jitter, Jmax, of the packet delayed variance value changes depending on the status of the network to achieve the optimal results expected.

14. The network bandwidth monitoring and regulating system as claimed in claim 1 or 9, wherein the average variance value of the jitter, Jave, of the packet delayed variance value changes depending on the status of the network to achieve the optimal results expected.
